(19) United States
(12) Patent Application Publication
(10) Pub. No.: US 2026/0133085 A1
(43) Pub. Date: May 14, 2026

(54) Force and/or Torque Sensor Employing Multiple Sensing Technologies

(71) Applicant: ATI Industrial Automation, Inc., Apex, NC (US)

(72) Inventor: Joseph Lipsey, Lillington, NC (US)

(21) Appl. No.: 19/381,613

(22) Filed: Nov. 6, 2025

Related U.S. Application Data
(60) Provisional application No. 63/718,213, filed on Nov. 8, 2024.

(51) Int. Cl. G01L 3/08; B25J 13/08; G01L 1/14; G01L 1/18; G01L 1/22; G01L 1/24; G01L 1/25; G01L 3/10; G01L 5/00

(52) U.S. Cl. CPC G01L 3/08; G01L 1/142; G01L 1/18; G01L 1/2262; G01L 1/246; G01L 1/255; G01L 3/108; G01L 5/0061; B25J 13/085

(57) ABSTRACT

A Force/Torque sensor employs transducers of two or more different sensing technologies to sense strains in a deformable member, and transduce those strains into output signals that are processed to resolve forces and/or torques between attached objects. The use of multiple, different sensing technologies may overcome the negative intrinsic properties of transducers made using one or both of the sensing technologies. Transducers of one technology may validate the outputs of transducers of the another technology, for example confirming that it is not an artifact of temperature, light, etc. The use of multiple, different sensing technologies facilitates robust, safe F/T sensors appropriate for critical safety applications.

### RELATED APPLICATIONS

This application claims the benefit of U.S. Provisional Application No. 63/718213, filed 8 Nov. 2024, the entire disclosure of which being hereby incorporated by reference herein.

### FIELD OF INVENTION

The present invention relates generally to force and torque sensors, and in particular to a sensor employing multiple, disparate sensing technologies for redundancy, verification, and the like.

### BACKGROUND

Robots are an indispensable part of manufacturing, testing, assembly, and packing of products; assistive and remote surgery; space exploration; operation in hazardous environments; and many other applications. Many robots and robotic applications require quantization of forces applied or experienced, such as material removal (grinding, sanding, and the like), parts assembly, remote digging or other manipulation of the environment, and the like.

An industrial robot typically comprises a general-purpose actuator, or “arm,” which comprises numerous segments connected by electromechanical joints that move and rotate in different axes and planes, providing numerous degrees of freedom. A six degrees of freedom (6-DOF) robot arm is commonly used in industrial manufacturing, including operations such as welding, material handling, material removal, painting, and the like. The 6-DOF design provides motion in the x-, y-, and z-planes, and the flexibility, strength, and reach for many tasks. It can perform roll, pitch, and yaw movement of a robotic tool, or “end effector,” which interacts with a workpiece.

In many applications, it is necessary or desirable to monitor the forces between an end effector and a workpiece. For example, in “force control” tasks, the end effector is controlled to apply a predetermined force (or force within a predetermined range), requiring the contact force and/or torque to be measured and fed back to the robot control system. There are two conventional approaches to measuring forces and torques at the end of a 6-DOF robot: measuring torques at each of numerous joints of the robot, and calculating the resulting forces and torques at the end; and placing a 6-axis force/torque (F/T) sensor between the robot and end effector.

Robot joint torques can be estimated from motor currents. However, these results tend to be noisy. Alternatively, a joint torque sensor can be installed in each of several joints. Joint torque sensors tend to have higher accuracy and higher signal to noise ratio. Conventional joint torque sensors may follow the 6-axis force/torque sensor design described above, with adjustments to the sensor geometry and/or strain gage placement based on the requirement that only one torque (Tz) must be measured.

Known joint torque sensors have numerous deficiencies. They are usually sensitive to off-axis loads. That is, forces and torques other than the desired Tz will cause beam deformation and generate strain gage output, which may manifest as errors in the axial torque Tz measurement. Known joint torque sensor designs are also sensitive to torque ripple, which is often found when measuring torques close to strain wave gearboxes, also known as harmonic drives. The torque ripple is a periodic fluctuation in the torque measurement, which is difficult to compensate. Even after modifying the 6-axis force/torque sensor design to measure only axial torque Tz, the sensors, with precisely machined thin features (e.g., flexures) and numerous strain gages, are still expensive to manufacture. Because several of them are needed to instrument a 6-DOF robot arm, this approach remains cost-prohibitive in many applications.

U.S. Pat. No. 10,422,707, assigned to the assignee of the present application and incorporated herein by reference in its entirety, describes a compact 6-axis F/T sensor. The sensor is based on a conventional design comprising a hub (connected to the tool) connected to an annular ring (connected to the robot) by a plurality of deformable beams, which include flexures to increase the beams'deformation under load. Strain gages affixed to the deformable beams measure tension and compression in the beams'surfaces as they deform under applied loads, and strain gage circuit outputs are decoded and mapped to six forces (Fx, Fy, Fz) and six torques (Tx, Ty, Tz) via a decoupling matrix developed during a calibration procedure. In general, a minimum of six strain gages is required, and many designs utilize many more strain gages (for example, mounting them to opposite sides, or all four sides, of each deformable beam). Also, as described in the '707 patent, one or more non-stressed strain gages may also be used to provide a baseline for temperature compensation, to reduce errors introduced by thermal drift.

FIG. 1 shows one example of an F/T sensor 5 employed in an industrial automation environment 1, such as manufacturing. A generally fixed robot arm 2, capable of translational or rotational movement in six orthogonal axes, also known as a 6 Degree of Freedom (6 DOF) robot arm 2, controls a robotic tool 3, also known as an end effector, which in the example depicted is a gripper. The robotic tool 3 is connected to the robot arm 2 by a robotic tool changer 4. As known in the art, a robotic tool changer 4 comprises a master unit 4M permanently attached to the robot arm 2 and a tool unit 4T permanently attached to each robotic tool 3 that the robot 2 may utilize. The robotic tool changer 4 provides a known mechanical interface between the robot arm 2 and each robotic tool 3, facilitating the use of a variety of robotic tools 3, which amortizes the cost of the system 1 over a large set of tasks, such as manufacturing operations, that the system 1 may perform.

The F/T sensor 5 is interposed in the end effector stack, e.g., between the robot arm 2 and the robotic tool changer master unit 4M. The F/T sensor 5 measures forces and torques between the robotic tool 3 and the robot arm 2. By monitoring these forces and torques, a robot control system (not shown) can detect contact of a robotic tool 3 with a workpiece, control the force of an operation (e.g., sanding or grinding) preformed on a workpiece, and the like. The F/T sensor 5 may be mounted anywhere in the end effector stack (e.g., between the tool unit 4T of the robotic tool changer and the tool 3).

The following patents and publications are assigned to the assignee of the present application and incorporated herein by reference in their entireties:
U.S. Pat. No. 10,067,019 Force/Torque Sensor Having Redundant Instrumentation and Operative to Detect Faults
U.S. Pat. No. 11,085,838 Force/Torque Sensor Having Serpentine or Coiled Deformable Beams and Overload Beams
U.S. Pat. No. 11,137,300 Robotic Force/Torque Sensor with Improved Temperature Compensation
U.S. Pat. No. 11,491,663 Robotic Force/Torque Sensor with Controlled Thermal Conduction
U.S. Pat. No. 11,747,224 Quarter-Bridge Temperature Compensation for Force/Torque Sensor
U.S. Pat. No. 11,892,364 Torque Sensor Using Coupled Loads and Fewer Strain Gages
2023/0049155 Gravity and Inertial Compensation of Force/Torque Sensors

A number of sensing technologies may be deployed in F/T sensor transducers to sense strains caused by deformations of internal parts, which are then resolved into forces and torques. To manage cost and complexity, in any given F/T sensor, all of the transducers are of the same technology.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, an F/T sensor employs transducers of two or more different sensing technologies to sense strains in a deformable member and transduce those strains into output signals that are processed to resolve forces and/or torques between attached objects. The use of multiple, different sensing technologies may overcome the negative intrinsic properties of transducers made using one or both of the sensing technologies. Transducers of one technology may validate the outputs of transducers of another technology, for example confirming that it is not an artifact of temperature, light, etc. The use of multiple, different sensing technologies facilitates robust, safe F/T sensors appropriate for critical safety applications.

One embodiment relates to a force and/or torque sensor configured to measure force and/or torque between first and second objects. The sensor includes a first substructure configured to attached to the first object; a second substructure configured to attached to the second object; and a plurality of deformable members connecting the first and second substructures. The sensor further includes a plurality of transducers attached to at least some deformable members. The transducers are configured to sense tensile or compressive strains in the deformable members and transduce the strains into output signals. The sensor additionally includes a controller configured to calculate force and/or torque between the first and second objects from the transducer output signals. The transducers comprise at least one transducer of a first sensing technology and at least one transducer of a different, second sensing technology.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a perspective view of a robot arm with attached robotic tool.

FIG. 2 is a plan view of an F/T sensor (FIG. 1 of the '707 patent cited above), utilizing multiple sensor technology according to aspects of the present disclosure.

FIG. 3 is an enlarged view of the F/T sensor of FIG. 2 under an applied force (FIG. 2 of the '707 patent cited above).

FIG. 4 is a plan view of a deformable beam in an F/T sensor, with two pairs of strain gages attached, each pair being of a different sensing technology.

FIG. 5 is a flow diagram of a method of measuring force and/or torque between first and second objects.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

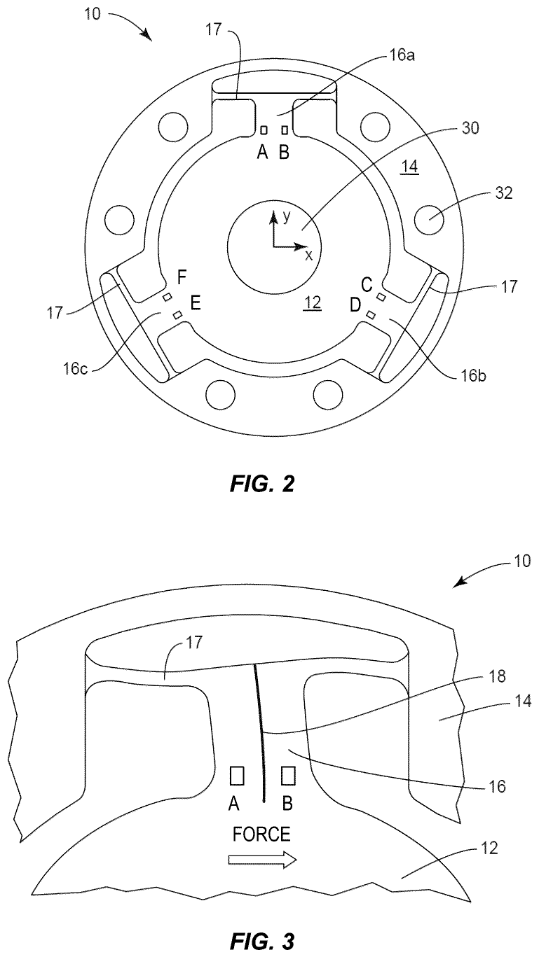

FIG. 2 depicts a plan view of one embodiment of an F/T sensor 10. A central “hub,” referred to in the art as a Tool Adapter Plate (TAP) 12 is connected to a tool. Another body arranged annularly around, and spaced apart from, the TAP, referred to in the art as a Mounting Adapter Plate (MAP) 14, is connected to a robotic arm. The TAP 12 and MAP 14 are connected to each other by a plurality of relatively thin (and hence mechanically deformable) beams 16a-c, arranged radially around the TAP 12 - in the example shown, resembling spokes of a wheel. Relative force or torque between objects respectively attached to the TAP 12 and MAP 14 attempt to move the MAP 14 relative to the TAP 12, resulting in slight deformation, or bending, of at least some of the beams 16.

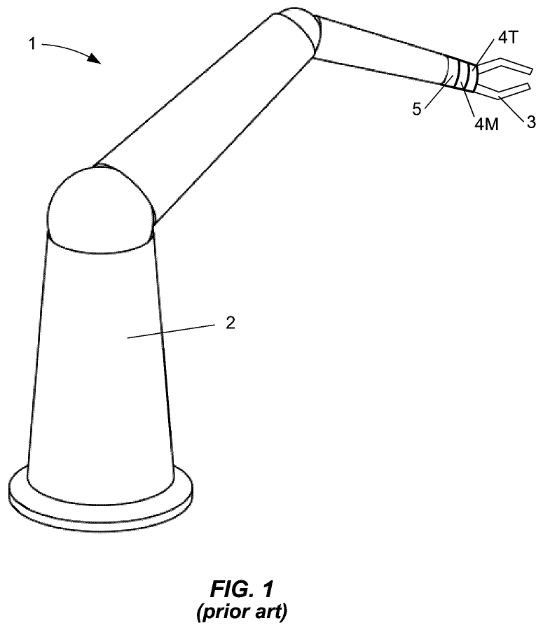

In the example shown in FIG. 2, each beam 16 connects directly to the TAP 12, and connects to the MAP 14 by flexures 17, which aids in the deformation of the beams 16 under mechanical loading. The TAP 12 is configured to be connected to a first object, such as a robotic tool, via a through-hole 30 or by tapped holes in the underside of the sensor 10 (not shown in FIG. 1). The MAP 14 is configured to be connected to a second object, such as a robot arm, via a plurality of mounting holes 32. Although not clear from this view, the TAP 12 and MAP 14 are only connected by the beams 16. Strain gages A-E are affixed to the upper surface of each deformable beam 16.

FIG. 3 is an enlarged view of one beam 16a undergoing deformation due to a FORCE applied to the TAP 12, relative to the MAP 14. This FORCE deforms the beam 16a slightly to the left (the figure is not to scale). A compressive force is induced on the left side surface of beam 16a, and a tensile force is induced on the right side surface. Strain gages mounted on these surfaces generate strong signals, of opposite polarity, from which the deformation, and hence the applied FORCE, is ascertained. Additionally, the two sides of the upper surface of the beam 16a also experience the compressive and tensile strain, in a magnitude that increases with distance away from a neutral axis 18. The neutral axis 18 is the line, running generally down the center of the upper surface of the beam 16a, at which compressive strain experienced on the left side of the beam 16a transitions to tensile strain on the right side. Accordingly, the beam 16a undergoes no strain at the neutral axis 18.

While the “hub and spoke” configuration described above is a common design, in general F/T sensors may assume a wide range of shapes and configurations. In all such configurations, a first substructure (e.g., TAP 12) connects to a first object (e.g., robotic tool) and a second substructure (e.g., MAP 14) connects to a second object (e.g., robot). Deformable members (e.g., beams 16) connect the first and second substructures. Transducers (e.g., strain gages) sense compressive and/or tensile strains in the deformable members, and transduce these into some form of output signal, which can be processed to resolve forces and/or torques between the first and second objects.

Numerous technologies are known for the transducers that sense the compressive and/or tensile strains in deformable members, and hence can be used to build F/T sensors, including those of the type depicted in FIGS. 2 and 3. The most common such technologies include:
Capacitive Deflection Sensing;
Semiconductor Piezoresistive Strain Gages;
Fiber Bragg Grating;
Reflective Optical Sensing;
Surface Acoustic Wave;
Metal Foil Strain Gages; and
Metal/Ceramic Sputtered Strain Gages.

Capacitive Sensing is relatively low cost with low-cost electronics needed to utilize it. High end electronics to measure this technology are expensive if high precision is needed. The signals from the measurement circuit are analog but could use coaxial signal cables for reduced signal noise.

Of all the sensing technologies, Semiconductor Piezoresistive Strain Gages have the highest sensitivity. However, they are very susceptible to changes in temperature and/or light. The measurement circuit has analog signals that require amplification to reduce noise in a long cable.

In Fiber Bragg Grating (FBG) sensors, when light travels through the fiber, periodic changes in the refractive index cause constructive interference at the Bragg wavelength, reflecting it back, while transmitting other wavelengths. This allows FBG sensors to transmit signals in an optical manner, which will typically introduce less noise than analog signal transmission. The signals are also more tolerant to electromagnetic influence, and are easy to protect from ingress, since they are less effected by moisture. FBG sensors typically respond poorly to changes in temperature and do not have high resolution.

It is typically difficult to achieve high levels of accuracy with Reflective Optical sensors, but they are relatively simple and are agnostic to many types of environments that typically affect Piezoresistive strain gages.

Surface Acoustic Wave (SAW) sensing technology utilizes acoustic waves that travel along the surface of a material to detect and measure various physical deformations or changes. These sensors typically consist of a piezoelectric substrate with transducers patterned on its surface. When an electrical signal is applied to the transducers, it generates mechanical waves that propagate along the surface of the substrate. This type of sensing is generally very robust, lightweight, and small in size. It can be sensitive to humidity and temperature.

Metal Foil/Metal or Ceramic Sputtered Strain gages are typically low in resolution, but very high in stability. The signals need significant amplification to be useable in high-fidelity applications.

In the prior art, F/T sensors are designed using one of these sensing technologies, and incorporate compensation methods for the upsides and downsides to that technology.

According to aspects of the present disclosure, two or more types of sensing technologies are used on shared sensing structures. Each technology of transducers provides a means to check the viability of the output of the other(s), with regards to a multi-axis force and/or torque sensor. Multi-technology transducers are also used as a safety circuit, where an error can be raised if there is a disagreement between the outputs of transducers employing the different sensing technologies.

According to one aspect, Piezoresistive Strain gage is used on a beam structure to detect deflections, with a redundant Metal Foil Strain gage. Since Metal foil gages typically have higher stability but lower sensitivity, the Piezoresistive Strain Gage is used as the primary strain gage during normal operation. Strain spikes and/or drifting outputs are compared between the gages of different technologies to ensure that the sensed strain actually exists, and is not an artifact due to the temperature or light instability of piezoresistive strain gages. The use of two sensing technologies is also used as a redundant safety system. A divergence in output between the gages of different technologies is detected, and causes a safety flag to be raised in the system's controls.

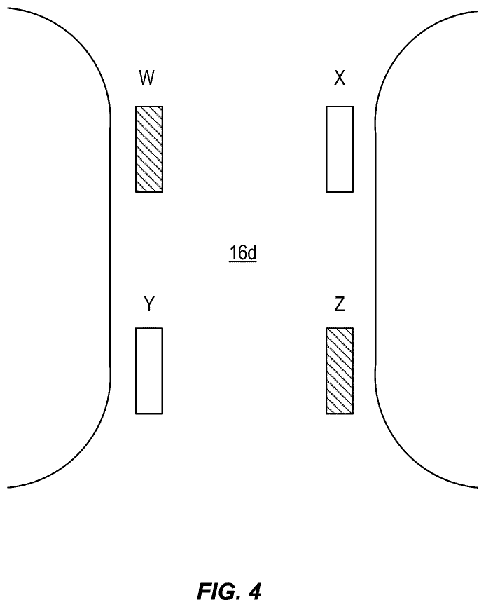

FIG. 4 shows a sensing structure with four strain gages W-Z adhered to a deformable beam 16d. Two of the four, X and Y, are Piezoresistive strain gages, and the other two, W and Z, are Metal Foil Strain gages.

In another aspect, Fiber Bragg Grating transducers are used to create signals that are easily transferable over a long distance, to check signals from a piezoresistive sensor. This help filters environmental noise from the transfer of analog signals.

In another aspect, semiconductor piezoresistive sensing elements that have built-in capacitive elements are used, and both sensing technologies are used in tandem.

In another aspect, Semiconductor Piezoresistive sensing elements are integrated with sputtered ceramic or metal. This creates a single sensing element with both types of strain sensing technology.

In another aspect, Sputtered Polysilicon Piezoresistive sensing elements are integrated onto foil strain gages.

In other aspects, more than two sensing technologies are deployed in the same F/T sensor.

In other aspects, any of the two or more sensing technologies described above may be advantageously combined in an F/T sensor.

In any of the aspects of the present disclosure, the two (or more) signals from the different sensing technologies are compared, for example in an electric circuit such as a Wheatstone bridge, or by converting analog sensor outputs to the digital domain, and comparing the outputs in a digital signal processor or other digital control or computational circuit.

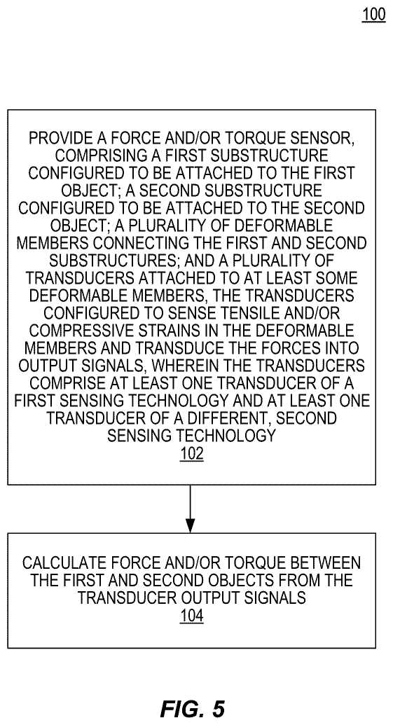

FIG. 5 depicts the steps in a method of measuring force and/or torque between first and second objects. A force and/or torque sensor is provided (block 102). The F/T sensor comprises a first substructure configured to be attached to the first object, and a second substructure configured to be attached to the second object. The F/T sensor further comprises a plurality of deformable members connecting the first and second substructures, and a plurality of transducers attached to at least some deformable members. The transducers are configured to sense tensile and/or compressive strains in the deformable members, and to transduce the forces into output signals. The transducers comprise at least one transducer of a first sensing technology and at least one transducer of a different, second sensing technology. Force and/or torque between the first and second objects is calculated from the transducer output signals (block 104).

Although aspects of the present disclosure are described herein, and depicted in the drawing figures, using strain gages 16, in general, the sensing technologies may comprise any transducers that sense tensile or compressive strains in response to applied forces and/or torques, and that output a responsive signal. The output signal may be electrical, optical, acoustic, magnetic, or of any other form. Individual transducers of different technologies may be used. Alternatively or additionally, different sensing technologies may be integrated into the same individual transducer. As used herein, such a dual-technology transducer comprises both one transducer of a first sensing technology and another transducer of a different, second sensing technology.

Aspects of the present disclosure present numerous advantages over the prior art. The use of two or more different strain sensing technologies enables the creation of robust, safe F/T sensors, suitable for critical safety applications. The outputs of one sensor technology may provide a “sanity check” on the outputs of another sensor technology, for example, verifying the presence of actual forces or torques, as opposed to environmental factors such as temperature or light that may affect the two sensor technologies differently. A sensor comprising disparate strain gage technologies is inherent more robust than one that relies on only one technology. For example, one technology may be susceptible to electromagnetic interference (in the extreme case, an electromagnetic burst), which may render it inoperative or severely compromised, while the other technology may exhibit a greater resistance to the interference, and be able to continue providing useful signals, from which F/T data may be computed. In general, sensing technologies may be combined to compliment each other, thus overcoming the negative intrinsic aspects of each technology.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa.

As used herein, the term “configured to” means set up, organized, adapted, or arranged to operate in a particular way; the term is synonymous with “designed to.” As used herein, the term “substantially” means nearly or essentially, but not necessarily completely; the term encompasses and accounts for mechanical or component value tolerances, measurement error, random variation, and similar sources of imprecision.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended embodiments are intended to be embraced therein.

1. A force and/or torque sensor configured to measure force and/or torque between first and second objects, comprising:
a first substructure configured to be attached to the first object;
a second substructure configured to be attached to the second object;
a plurality of deformable members connecting the first and second substructures; and
a plurality of transducers attached to at least some deformable members, the transducers configured to sense tensile and/or compressive strains in the deformable members and transduce the forces into output signals; and
a controller configured to calculate force and/or torque between the first and second objects from the transducer output signals;
wherein the transducers comprise at least one transducer of a first sensing technology and at least one transducer of a different, second sensing technology.

2. The sensor of claim 1, wherein a signal output by a transducer is an electrical signal.

3. The sensor of claim 1, wherein a signal output by a transducer is an optical signal.

4. The sensor of claim 1, wherein a signal output by a transducer is an acoustic signal.

5. The sensor of claim 1, wherein a signal output by a transducer is a magnetic signal.

6. The sensor of claim 1, wherein one of the first and second sensing technologies is Capacitive Deflection Sensing.

7. The sensor of claim 1, wherein one of the first and second sensing technologies is a Semiconductor Piezoresistive Strain Gages.

8. The sensor of claim 1, wherein one of the first and second sensing technologies is a Fiber Bragg Grating.

9. The sensor of claim 1, wherein one of the first and second sensing technologies is Reflective Optical Sensing.

10. The sensor of claim 1, wherein one of the first and second sensing technologies is a Surface Acoustic Wave device.

11. The sensor of claim 1, wherein one of the first and second sensing technologies is a Metal Foil Strain Gage.

12. The sensor of claim 1, wherein one of the first and second sensing technologies is a Metal/Ceramic Sputtered Strain Gage.

13. The sensor of claim 1, wherein the first sensing technology is a Piezoresistive Strain gage and the second sensing technology is a Metal Foil Strain gage.

14. The sensor of claim 1, wherein the first sensing technology is a Piezoresistive Strain gage and the second sensing technology is a Fiber Bragg Grating.

15. The sensor of claim 1, wherein the first sensing technology is a Piezoresistive Strain gage and the second sensing technology is a sputtered ceramic or metal and wherein both technologies are integrated into the same transducer.

16. The sensor of claim 1, wherein the first sensing technology is a Metal Foil Strain gage and the second sensing technology is a Sputtered Polysilicon Piezoresistive sensing element and wherein both technologies are integrated into the same transducer.

17. The sensor of claim 1, wherein the controller comprises a Wheatstone bridge electrical circuit.

18. The sensor of claim 1, wherein the controller comprises a Digital to Analog Converter.

19. The sensor of claim 1, wherein the controller further comprises digital processing circuitry.

20. A method of measuring force and/or torque between first and second objects, comprising:
providing a force and/or torque sensor, comprising:
a first substructure configured to be attached to the first object;
a second substructure configured to be attached to the second object;
a plurality of deformable members connecting the first and second substructures; and
a plurality of transducers attached to at least some deformable members, the transducers configured to sense tensile and/or compressive strains in the deformable members and transduce the forces into output signals, wherein the transducers comprise at least one transducer of a first sensing technology and at least one transducer of a different, second sensing technology; and
calculating force and/or torque between the first and second objects from the transducer output signals.
